(19) United States
(12) Patent Application Publication
(10) Pub. No.: US 2016/0329708 A1
(43) Pub. Date: Nov. 10, 2016

(54) DAY AHEAD LOAD NOMINATION SYSTEM

(71) Applicant: Trane International Inc., Davidson, NC (US)

(72) Inventor: Michael Sean Day, Sacramento, CA (US)

(73) Assignee: Trane International Inc., Davidson, NC (US)

(21) Appl. No.: 15/142,586

(22) Filed: Apr. 29, 2016

Related U.S. Application Data
(60) Provisional application No. 62/157,310, filed on May 5, 2015.

(51) Int. Cl. H02J 3/14; G06Q 30/08; G05B 15/02

(52) U.S. Cl. CPC H02J 3/14; G05B 15/02; G06Q 30/08; H02J 2003/003

(57) ABSTRACT

Systems and methods are disclosed for enabling an operator of a load facility to nominate a specific level of load curtailment into an auction or scheduling mechanism of an independent system, transmission, or distribution system operator (ISO). A load operator manages demand requirements for a subsequent day using a user interface, which in one embodiment provides a view of expected demand, curtailment bid, and backfill planning on an hourly basis. Demand curtailment bids are communicated to the power transmission system operator. Accepted bids are displayed on the user interface. In embodiments, the power transmission system operator communicates curtailment instructions to the load facility to manage process scheduling and/or on-site generation capabilities to effectuate demand reduction. The described systems and methods provide enhanced flexibility to load facility operators to maintain needed control, helps ensure the lack of negative impacts on core processes, and encourages participation in demand-side management initiatives.

### CROSS-REFERENCE TO RELATED APPLICATION

This application claims the benefit of and priority to U.S. Provisional Application Ser. No. 62/157,310 entitled “DAY AHEAD LOAD NOMINATION SYSTEM” and filed May 5, 2015, the entirety of which is hereby incorporated by reference herein for all purposes.

### BACKGROUND

1. Technical Field

The present disclosure is directed to transmission system demand-side management, and in particular, to systems and methods for flexibly nominating load curtailment and energy backfill requirements into an energy auction and/or scheduling mechanism of an independent system, transmission, or distribution system operator.

2. Background of Related Art

Electrical generating utilities generally negotiate production requirements with regional transmission organizations and independent system, transmission, or distribution system operators (ISO). ISOs are responsible for the operation of the electrical transmission system, commonly known as the power grid. ISOs use a variety of techniques, collectively known as load balancing, to match power generation capabilities to demand. In some instances, a utility is able to throttle its power generation resources to match demand, such as those that rely on hydroelectric generators which are readily and rapidly adaptable to varying load demands. However, other power generation technologies present challenges in this regard. For example, the power-generation capacity of wind-powered and solar-powered generation facilities is dependent upon external environmental conditions and therefore difficult to control on an as-needed basis.

One load-balancing technique which is gaining widespread acceptance is known as demand-response. Demand-response is the practice of incentivizing consumers of electricity to change their electrical usage patterns by reducing loads and by time-shifting use from periods of overall high grid demand to periods where grid demand is lower. Demand-response creates a secondary market for energy that is not used, sometimes referred to as “negawatt-hours,” a theoretical unit that represents the amount of energy saved or deferred. In return for curtailing electrical use, electrical consumers may receive reduced electrical rates or earn incentive payments.

Demand response arrangements may have drawbacks. For engineers and operators involved in industrial plant processes, a top priority is to avoid process disruption, particularly when altering the plant process can result in damage or safety concerns. Because of this, process plant operators will often forego opportunities to achieve energy savings, because the savings are simply not worth the risk of process disruption. These risks exist for most industrial processes and are particularly acute for wastewater treatment plant (WWTP) operations.

WWTPs rely upon activated sludge, a biologic process, to break down waste. This biologic process is energy-intensive and requires pumping, motorized straining, ultraviolet (UV) disinfection, and, most importantly, a considerable amount of energy to continually perform the aeration. Aeration is needed to maintain the biological parameters (“biologicals”) within viable dissolved O₂ limits. Dropping below those dissolved O₂ limits, even momentarily, can have devastating impacts to the aeration process. Although waste flow can be diverted to holding basins for later treatment, the diversion of flow does not result in an immediate reduction in power usage. Aeration blowers, in particular, must be allowed to continue to operate, or an unwanted and even hazardous condition can occur. For these reasons, WWTP operators are highly reluctant to engage in traditional demand response programs. A demand response system that encourages greater participation by process-critical facilities would be a welcome advance in the art.

### SUMMARY

In one aspect, the present disclosure is directed to an electric load curtailment nominating system for a load facility. In an exemplary embodiment, the electric load curtailment nominating system includes a computer processor, a memory, a first data transmission interface to a curtailment auctioning and control system, a second data transmission interface to a load facility control system, a user interface, and software code that, when loaded into the memory and run by the processor, causes the processor to accept entry of an amount of energy curtailment nominated for a first hour in a twenty-four hour period through the user interface.

In some embodiments, the processor accepts entry of an amount of additional energy needed in a second hour in the twenty-four hour period through the user interface to accommodate the amount of energy curtailment nominated in the first hour. In some embodiments, the user interface comprises a grid of boxes, wherein each box represents an amount of energy during a particular hour. In some embodiments, the processor determines a total amount of energy curtailment nominated. In some embodiments, the processor determines whether a total amount of additional energy matches the total amount of energy curtailment.

In some embodiments, the processor submits an amount of energy curtailment nominated in each hour of the twenty-four hour period and an amount of additional energy nominated in each hour of the twenty-four hour period through the first data transmission interface. In some embodiments, the processor receives an amount of energy curtailment awarded in each hour of the twenty-four hour period and an amount of additional energy awarded in each hour of the twenty-four hour period through the first data transmission interface. In some embodiments, the processor sends the amount of energy curtailment awarded in each hour of the twenty-four hour period and the amount of additional energy awarded in each hour of the twenty-four hour period through the second data transmission interface. In some embodiments, the processor receives an amount of energy used in each hour of the twenty-four hour period through the second data transmission interface.

In another aspect, the present disclosure is directed to a load facility having a plurality of electric loads. The load facility includes a load facility control system having a load control signal interface, and an electric load curtailment nominating system. The electric load curtailment nominating system includes a computer processor, a memory, a first data transmission interface to a curtailment auctioning and control system, a second data transmission interface to the load facility control system, a user interface, and software code that, when loaded into the memory and run by the processor, causes the processor to accept entry of an amount of energy curtailment nominated for a first hour in a twenty-four hour period through the user interface. In some embodiments, the software code further causes the processor to accept entry of an amount of additional energy needed in a second hour in the twenty-four hour period through the user interface to accommodate the amount of energy curtailment nominated in the first hour. In some embodiments, the user interface comprises a grid of boxes, wherein each box represents an amount of energy during a particular hour. In some embodiments, the software code further causes the processor to determine a total amount of energy curtailment nominated.

In some embodiments, the software code further causes the processor to determine whether a total amount of additional energy matches the total amount of energy curtailment. In some embodiments, the software code further causes the processor to submit an amount of energy curtailment nominated in each hour of the twenty-four hour period and an amount of additional energy nominated in each hour of the twenty-four hour period through the first data transmission interface. In some embodiments, the software code further causes the processor to receive an amount of energy curtailment awarded in each hour of the twenty-four hour period and an amount of additional energy awarded in each hour of the twenty-four hour period through the first data transmission interface.

In some embodiments, the software code further causes the processor to send the amount of energy curtailment awarded in each hour of the twenty-four hour period and the amount of additional energy awarded in each hour of the twenty-four hour period to the load facility control system. In some embodiments, the load facility control system controls the plurality of electric loads based on a load control signal received over the load control signal interface. In some embodiments, the software code further causes the processor to receive an amount of energy used in each hour of the twenty-four hour period from the load facility control system.

In yet another aspect, the present disclosure is directed to an electric load facility having an electric load auctioning, scheduling, and curtailment system. In an exemplary embodiment, the disclosed electric load facility and electric load auctioning and curtailment system includes a computerized electric load auctioning and curtailment control system and a load facility. The computerized electric load auctioning and curtailment control system conducts daily auctions of nominated electric load curtailment and awards electric load curtailment. The load facility includes a plurality of electric loads, a load facility control system that controls the plurality of electric loads, and having a load control signal interface, and an electric load curtailment nominating system. The electric load curtailment nominating system includes a computer processor, a memory, a first data transmission interface to the computerized electric load auctioning and curtailment control system, a second data transmission interface to the load facility control system, a user interface comprising a grid of boxes, wherein each box represents an amount of energy during a particular hour, and software code that, when loaded into the memory and run by the processor, causes the processor to accept entry of an amount of energy curtailment nominated for a first hour in a twenty-four hour period and an amount of additional energy needed in a second hour in the twenty-four hour period through the user interface to accommodate the amount of energy curtailment nominated in the first hour, submit an amount of energy curtailment nominated in each hour of the twenty-four hour period and an amount of additional energy nominated in each hour of the twenty-four hour period to the computerized electric load auctioning and curtailment control system through the first data transmission interface, and receive an amount of energy curtailment awarded by auction in each hour of the twenty-four hour period and an amount of additional energy awarded in each hour of the twenty-four hour period through the first data transmission interface.

Particular embodiments of the present disclosure have been described herein, however, it is to be understood that the disclosed embodiments are merely examples of the disclosure, which may be embodied in various forms. Well-known functions or constructions are not described in detail to avoid obscuring the present disclosure in unnecessary detail. Therefore, specific structural and functional details disclosed herein are not to be interpreted as limiting, but merely as a basis for the claims and as a representative basis for teaching one skilled in the art to variously employ the present disclosure in any appropriately detailed structure.

### BRIEF DESCRIPTION OF THE DRAWINGS

Various embodiments of the disclosed system and method are described herein with reference to the drawings wherein:

FIG. 1 is a block diagram of a day-ahead load nomination system in accordance with the present disclosure;

FIG. 2 illustrates a day-ahead load nomination system in accordance with the present disclosure in use to establish minimum power requirements of a load facility;

FIG. 3 illustrates a day-ahead load nomination system in accordance with the present disclosure in use to establish anticipated power requirements of a load facility;

FIG. 4 illustrates a day-ahead load nomination system in accordance with the present disclosure in use to nominate curtailment capacity;

FIG. 5 illustrates a day-ahead load nomination system in accordance with the present disclosure in use to plan backfill power requirements;

FIG. 6 illustrates a day-ahead load nomination system in accordance with the present disclosure displaying nominated curtailment versus actual curtailment;

FIG. 7 illustrates a day-ahead load nomination system in accordance with the present disclosure displaying requested backfill versus actual backfill; and

FIG. 8 illustrates a day-ahead load nomination system in accordance with the present disclosure displaying a load center curtailment and backfill history for a single day operation cycle.

The various aspects of the present disclosure mentioned above are described in further detail with reference to the aforementioned figures and the following detailed description of exemplary embodiments.

### DETAILED DESCRIPTION

Particular illustrative embodiments of the present disclosure are described hereinbelow with reference to the accompanying drawings; however, the disclosed embodiments are merely examples of the disclosure, which may be embodied in various forms. Well-known functions or constructions and repetitive matter are not described in detail to avoid obscuring the present disclosure in unnecessary or redundant detail. Therefore, specific structural and functional details disclosed herein are not to be interpreted as limiting, but merely as a basis for the claims and as a representative basis for teaching one skilled in the art to variously employ the present disclosure in virtually any appropriately detailed structure. In this description, as well as in the drawings, like-referenced numbers represent elements which may perform the same, similar, or equivalent functions. The word “exemplary” is used herein to mean “serving as an example, instance, or illustration.” Any embodiment described herein as “exemplary” is not necessarily to be construed as preferred or advantageous over other embodiments. The word “example” may be used interchangeably with the term “exemplary.”

The present disclosure is described herein in terms of functional block components and various processing and communication steps. It should be appreciated that such functional blocks configured to perform the specified functions may be embodied in analog circuitry, digital circuitry, and/or instructions executable on a processor. For example, the present disclosure may employ various discrete components, integrated circuit components (e.g., memory elements, processing elements, communications elements, logic elements, look-up tables, and the like) which may carry out a variety of functions, whether independently, in cooperation with one or more other components, and/or under the control of one or more processors or other control devices. It should be appreciated that the particular implementations described herein are illustrative of the disclosure and its best mode and are not intended to otherwise limit the scope of the present disclosure in any way.

The present disclosure is directed to a day-ahead load nomination system and related methods. Plant engineers are tasked with establishing the minimum baseline energy requirements of an energy-usage facility, and may accomplish this task in a number of ways. For example, the plant engineer may conduct a survey to establish the minimum baseline energy requirements. In this instance, an engineer with experience in WWTPs will determine minimum flows, and hence energy requirements, that are necessary for safe operation of the plant. The plant operator then estimates the hour-by hour energy requirements for the next day. For example, a WWTP operator will estimate the process flow they anticipate for the next day. Additionally or alternatively, the plant engineer may deduce minimum baseline energy requirements on an analytic basis from past data regarding flows, power, day type, time of year, ambient conditions, and so forth.

Next, the plant operator selects how much of the next day's load will be offered for curtailment, on an hour-by-hour basis, between the anticipated load and the minimum required load. The plant operator may elect to offer all of the amount of curtailment available, or only a portion. From this selection, a curtailment offer, along with a bid price, is generated and submitted to a day ahead auction run by an ISO. The auction settles, and the ISO informs the plant engineers how much, if any, of their offered curtailment was accepted. This data is communicated to the plant operators. The next day, the control system allows the ISO to use any amount of curtailment between the selected bounds as a balancing, regulation, and support resource. In this manner, the disclosed day-ahead load nomination system provides an easily understood platform that facilitates faithful participation by plant operators, selection of offered resources by an ISO, dispatch of offered resources, and settlement.

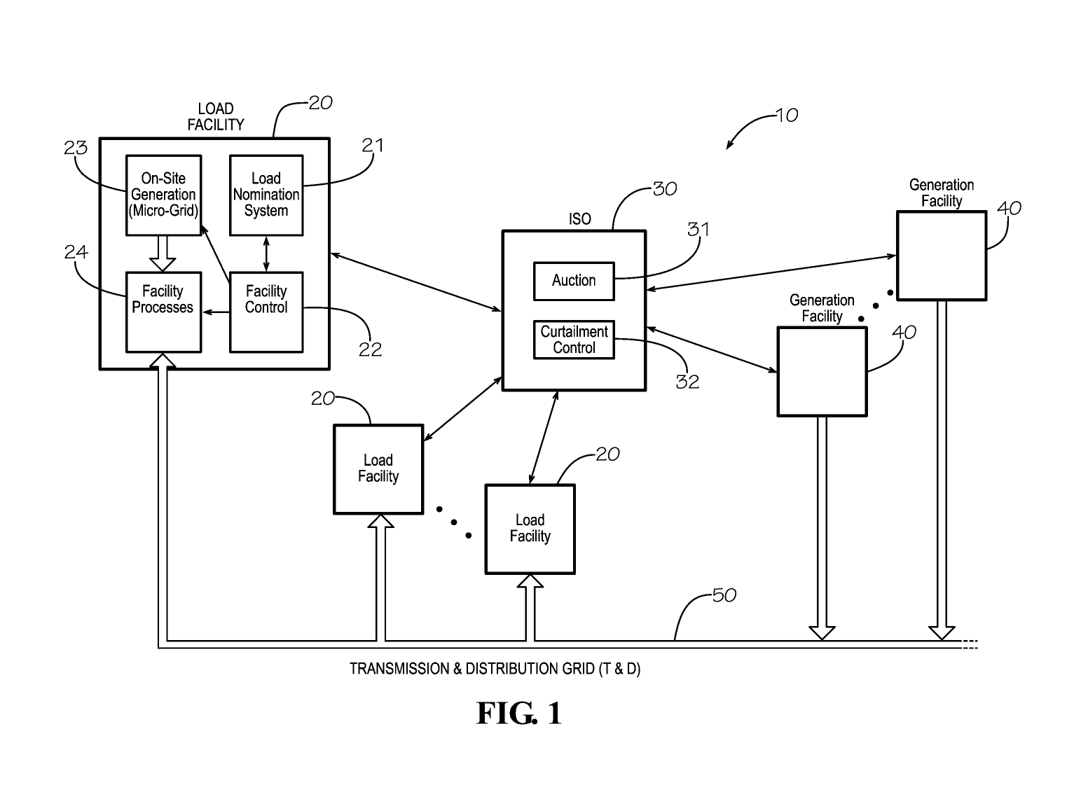

With reference to FIG. 1, an exemplary embodiment of an electric transmission and distribution (T&D) system 10 including a day ahead load nomination system 21 in accordance with the present disclosure is shown. T&D system 10 includes an independent system, transmission, or distribution system operator (ISO) 30 that is in operable communication with at least one load facility 20 and at least one generation facility 40. The generation facility 40 contributes power into a T&D grid 50 through which power is delivered to load facility 20. Load facility 20 may include any consumer of electrical power, including without limitation an industrial facility, commercial facility, residential facility, and so forth. In an embodiment, load facility 20 may include a wastewater treatment plant.

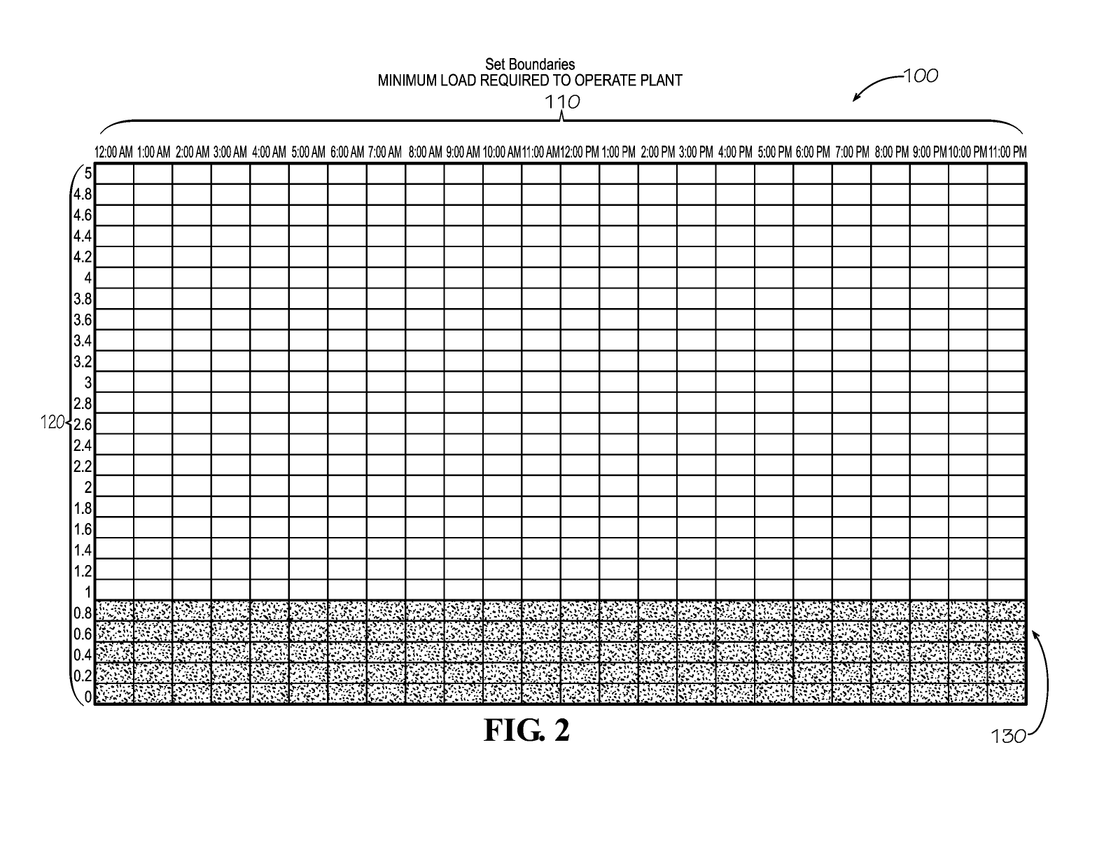

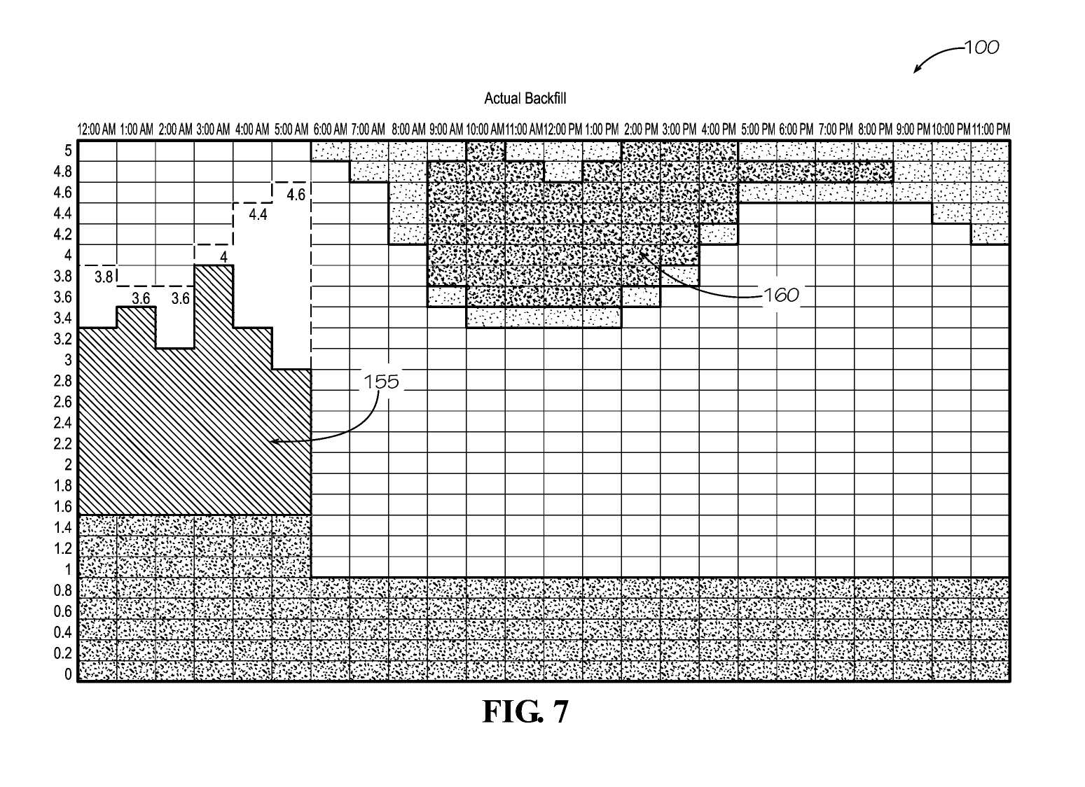

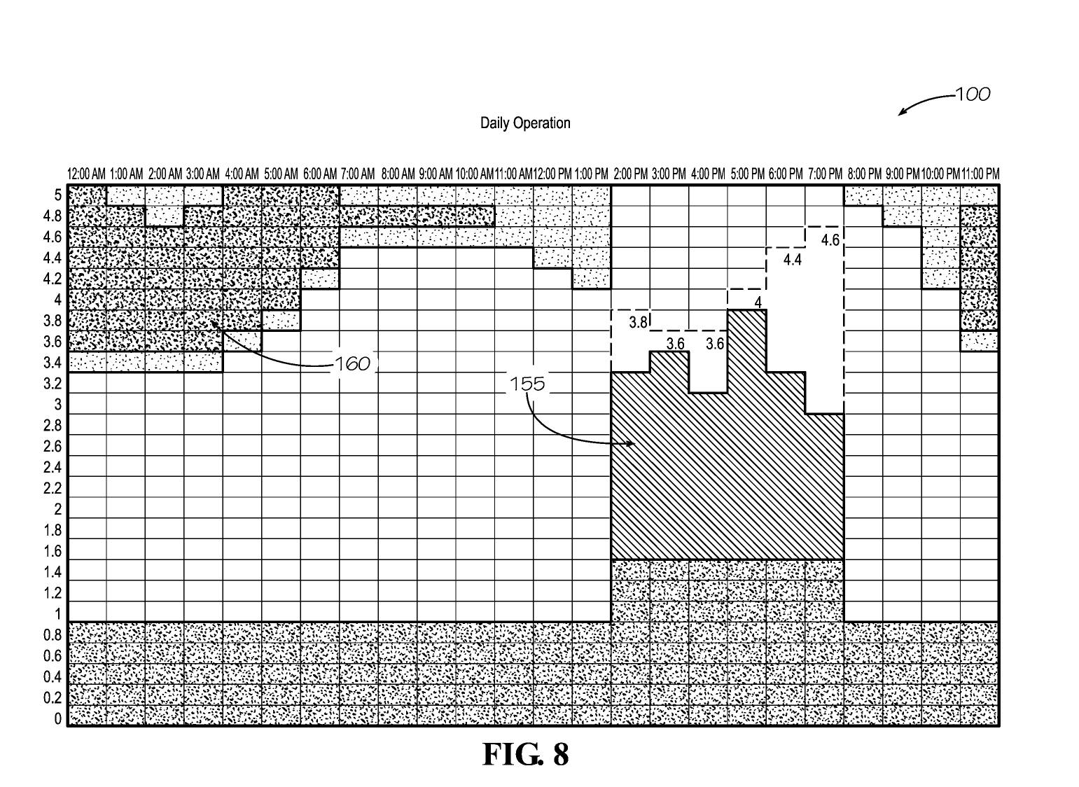

ISO 30 includes an auctioning system 31 and a curtailment control system 32. Auctioning system 31 is configured to receive power usage bids, such as, without limitation, curtailment bids and backfill bids, from the one or more load facilities 20, and to select a winning bid from among the submitted bids at the close of an auction period. A curtailment bid is an offer from a load facility 20 to ISO 30 to reduce energy consumption by a certain amount for a certain period of time in exchange for a credit. A backfill bid is an offer from a load facility 20 to ISO 30 to increase energy consumption by a certain amount for a certain period of time at a bid price, to consume energy whose use was deferred due to curtailment. In the embodiments described herein and illustrated with reference to FIGS. 2-8 described in detail below, energy savings and/or consumption may be bid in increments of 200 kW of power and in increments of one hour's time. However, it is to be understood that bids having different increments of power and/or time are contemplated within the scope of the present disclosure.

Winning bids are communicated from auctioning system 31 to curtailment control system 32. Curtailment control system 32, in turn, communicates with a facility control system 22 of the winning load facility 20 to schedule the power reduction or power increase as set forth in the winning bid and, optionally or alternatively, to automate the decrease or increase in power consumption by load facility 20.

Load facility 20 includes a load nomination system 21 that is in operable communication with facility control system 22. Winning bids are also communicated from auctioning system 31 to load nomination system 21. Facility control system 22 enables a plant operator to monitor and control the facility processes 24 and on-site generation resources 23 of load facility 20. For example, in embodiments where load facility 20 includes a wastewater treatment plant, facility processes 24 may include one or more pumps, motorized strainers, valves, UV disinfection units, and/or aeration units. On-site generation resources 23 may include storage batteries, generators (“gensets”), photovoltaic arrays, wind turbines, geothermal, and so forth. Advantageously, the inclusion of on-site generation resources 23 gives a plant operator increased freedom to schedule curtailment bids, since any unforeseen power shortfalls can be readily fulfilled by bringing one or more on-site generation resources 23 online on an as-needed basis. This provides a safety net which further encourages plant operator to participate in demand response or other demand side management programs.

In some embodiments, the auctioning system 31 may be bypassed or omitted, enabling curtailments to be selectively accepted on an ad-hoc basis.

Load nomination system 21 is in operable communication with facility control system 22 and auctioning system 31. Load nomination system 21 includes a user interface configured accept entry of load facility curtailment bids, backfill bids, and related load facility operational parameters, of which exemplary embodiments are shown in FIGS. 2-8. As seen in FIG. 2, user interface 100 includes a grid structure having a series of twenty-four columns 110 each representing an hour of the day, and a series of rows 120 each representing a 200 kW increment of electrical power. Although user interface 100 as illustrated employs a grid paradigm, it is contemplated that any suitable user interface paradigm may be advantageously employed within the scope of the present disclosure. Similarly, any suitable user input device may be employed to facilitate the selection and entry of bids, such as without limitation, a mouse, trackpad, touchscreen, tablet, voice recognition, gesture recognition, and so forth. Here, user interface 100 is configured to enable the plant engineer to define the absolute minimum load 130 required to operate the plant on an hour-by-hour basis, which, in the present example, has been set to 1.0 MW for each of the day's twenty-four hours.

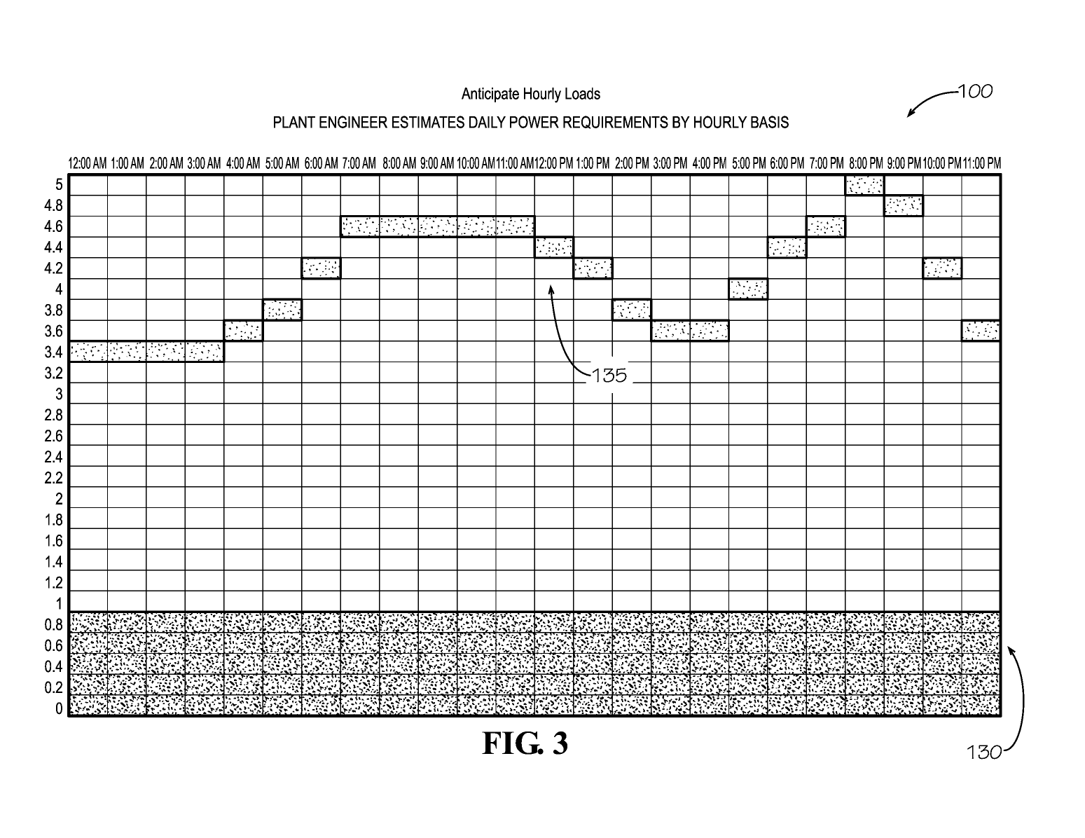

Turning to FIG. 3, user interface 100 is configured to enable the plant engineer to define the load facility's anticipated loads for the coming day, on an hour-by-hour basis. As shown, the anticipated load 135 is indicated by shaded boxes. As illustrated in FIG. 3, anticipated load varies from 3.4 MW at the 12:00 am hour to 5 MW at the 8:00 pm hour. The area between the minimum load 130 and the anticipated load 135 represents the loads which are potentially available for curtailment.

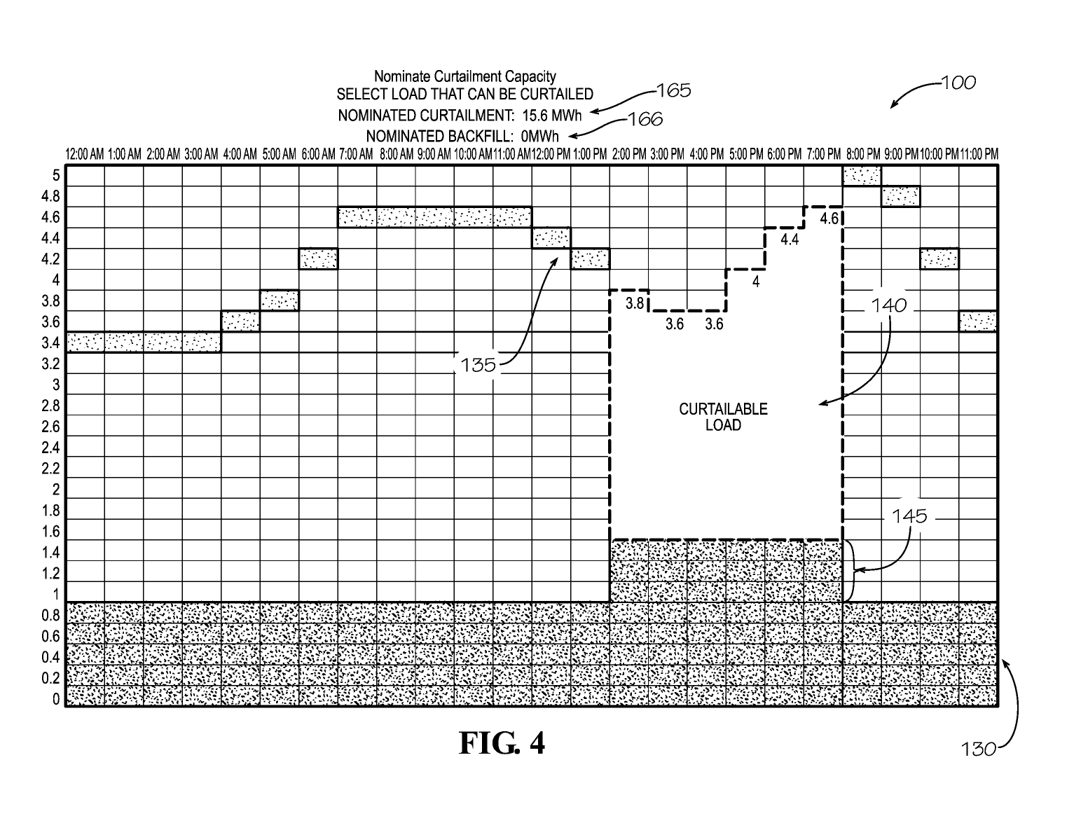

With reference now to FIG. 4, the plant engineer selects which of the potentially available loads will be bid out for curtailment. In the present example, the plant engineer has chosen to bid the full anticipated load from the 2:00 pm hour through the 7:00 pm hour down to a floor of 1.4 MW. That is, the load facility 20 is offering to use no more than 1.4 MW during these hours. Note that the plant engineer has chosen not to bid down to the absolute minimum load 135 of 1.0 MW, but rather, to leave a 1.4 MW cushion. This flexibility in scheduling and bidding again encourages plant operators to participate in demand response programs, because the described system enables the plant engineer to maintain control of the curtailment process. User interface 100 is configured to display the total nominated curtailment 165 as the plant engineer selects curtailment units for bid.

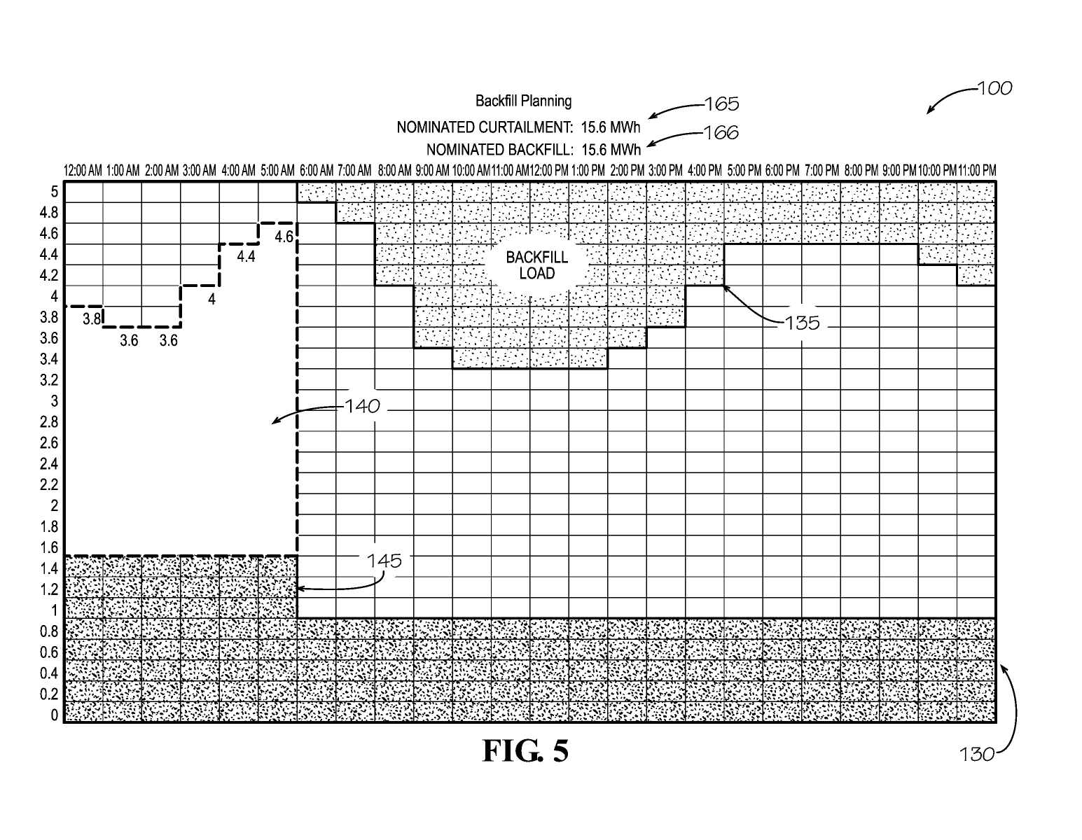

In many instances, energy consumption that was curtailed at a first time will need to be backfilled (e.g., consumed at a later time) in order to perform the processes which were suspended to accommodate the curtailment. Turning to FIG. 5, user interface 100 is configured to enable the plant engineer to define backfill loads, e.g., the additional consumption, to be bid out to the ISO 30. In the FIG. 5 example, the plant engineer has chosen to bid backfill loads ranging from the defined anticipated load 135 up to a ceiling of 5 MW from the 9:00 pm hour through the 1:00 pm hour. User interface 100 is configured to display the total nominated backfill 166 as the plant engineer selects backfill units for bid. Load nomination system 21 communicates the elected curtailment 140 and backfill 150 bids to auction system 31 of ISO 30. Auction system 31 determines the winning bids, and communicates the winning bid information to curtailment control system 32. Curtailment control system 32, in turn, communicates an automatic load control (ALC) signal to the facility control system 22 of the winning load facility 20 to automatically curtail and/or increase load in accordance with the winning bid. Note that, in some instances, the ISO may require only a partial curtailment at the agreed-upon time which will be so indicated by the automatic load control signal.

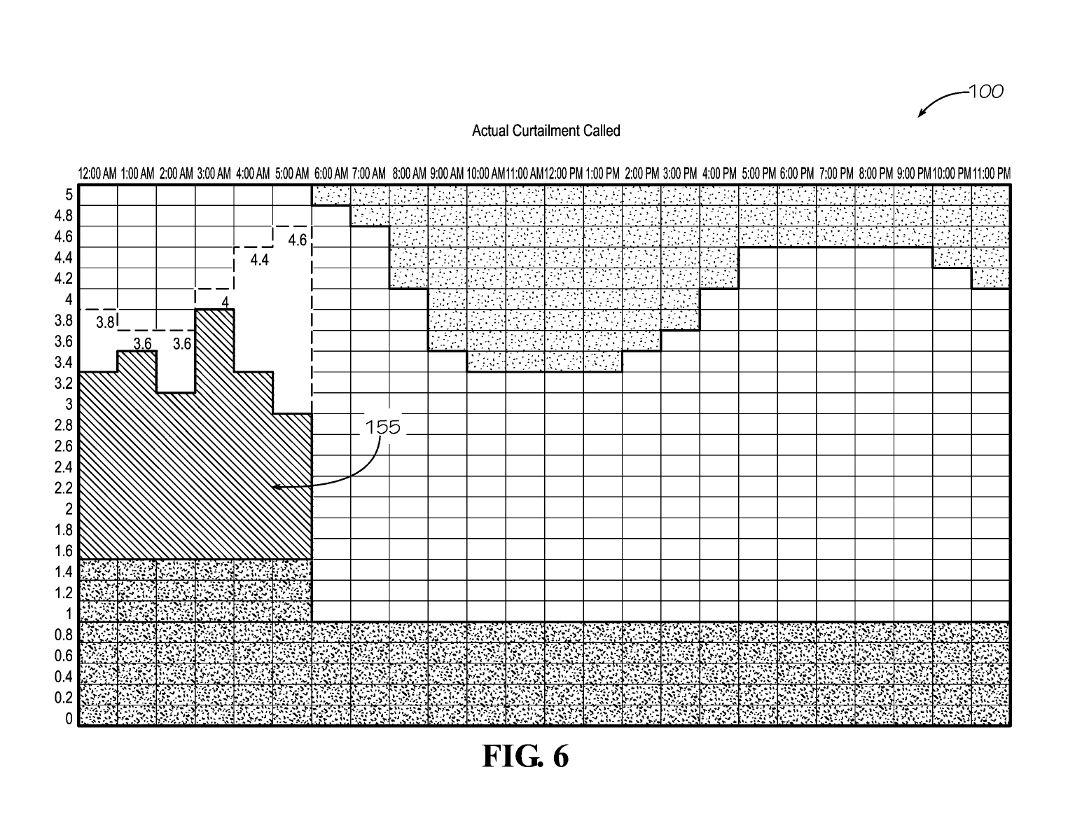

With attention now to FIGS. 6-8, user interface 100 is configured to provide historical information conveying the elected curtailment 140 and backfill 150 to the actual curtailment 155 (e.g., negawatt hours curtailed) and actual backfill usage 160 seen during the relevant twenty-four hour period. As shown, actual curtailment 155 is displayed as a hatched region and actual backfill 160 is displayed as a stippled region overlaying the respective elected curtailment 140 and elected backfill 155. Note that, in the example embodiments shown in FIGS. 6-8, actual curtailment 155 indicates the actual energy saved (negawatts) rather than actual energy used. Conversely, actual backfill 160 indicates actual energy additionally consumed at a later time to compensate for deferral of energy usage during curtailment.

### ASPECTS

It is noted that any of aspects 1-9, any of aspects 10-19, and/or aspect 20 may be combined with any other in any combination.

Aspect 1. An electric load curtailment nominating system for a load facility, comprising a computer processor; memory; a first data transmission interface to a curtailment auctioning and control system; a second data transmission interface to a load facility control system; a user interface; and software code that, when loaded into the memory and run by the processor, causes the processor to accept entry of an amount of energy curtailment nominated for a first hour in a twenty-four hour period through the user interface.

Aspect 2. The system of aspect 1, wherein the software code further causes the processor to accept entry of an amount of additional energy needed in a second hour in the twenty-four hour period through the user interface to accommodate the amount of energy curtailment nominated in the first hour.

Aspect 3. The system of any of aspects 1-2, wherein the user interface comprises a grid of boxes, wherein each box represents an amount of energy during a particular hour.

Aspect 4. The system of any of aspects 1-3, wherein the software code further causes the processor to determine a total amount of energy curtailment nominated.

Aspect 5. The system of any of aspects 1-4, wherein the software code further causes the processor to determine whether a total amount of additional energy matches the total amount of energy curtailment.

Aspect 6. The system of any of aspects 1-5, wherein the software code further causes the processor to submit an amount of energy curtailment nominated in each hour of the twenty-four hour period and an amount of additional energy nominated in each hour of the twenty-four hour period through the first data transmission interface.

Aspect 7. The system of any of aspects 1-6, wherein the software code further causes the processor to receive an amount of energy curtailment awarded in each hour of the twenty-four hour period and an amount of additional energy awarded in each hour of the twenty-four hour period through the first data transmission interface.

Aspect 8. The system of any of aspects 1-7, wherein the software code further causes the processor to send the amount of energy curtailment awarded in each hour of the twenty-four hour period and the amount of additional energy awarded in each hour of the twenty-four hour period through the second data transmission interface.

Aspect 9. The system of any of aspects 1-8, wherein the software code further causes the processor to receive an amount of energy used in each hour of the twenty-four hour period through the second data transmission interface.

Aspect 10. A load facility, comprising a plurality of electric loads; a load facility control system comprising a load control signal interface; and an electric load curtailment nominating system comprising a computer processor; memory; a first data transmission interface to a curtailment auctioning and control system; a second data transmission interface to the load facility control system; a user interface; and software code that, when loaded into the memory and run by the processor, causes the processor to accept entry of an amount of energy curtailment nominated for a first hour in a twenty-four hour period through the user interface.

Aspect 11. The load facility of aspect 10, wherein the software code further causes the processor to accept entry of an amount of additional energy needed in a second hour in the twenty-four hour period through the user interface to accommodate the amount of energy curtailment nominated in the first hour.

Aspect 12. The load facility of any of aspects 10-11, wherein the user interface comprises a grid of boxes, wherein each box represents an amount of energy during a particular hour.

Aspect 13. The load facility of any of aspects 10-12, wherein the software code further causes the processor to determine a total amount of energy curtailment nominated.

Aspect 14. The load facility of any of aspects 10-13, wherein the software code further causes the processor to determine whether a total amount of additional energy matches the total amount of energy curtailment.

Aspect 15. The load facility of any of aspects 10-14, wherein the software code further causes the processor to submit an amount of energy curtailment nominated in each hour of the twenty-four hour period and an amount of additional energy nominated in each hour of the twenty-four hour period through the first data transmission interface.

Aspect 16. The load facility of any of aspects 10-15, wherein the software code further causes the processor to receive an amount of energy curtailment awarded in each hour of the twenty-four hour period and an amount of additional energy awarded in each hour of the twenty-four hour period through the first data transmission interface.

Aspect 17. The load facility of any of aspects 10-16, wherein the software code further causes the processor to send the amount of energy curtailment awarded in each hour of the twenty-four hour period and the amount of additional energy awarded in each hour of the twenty-four hour period to the load facility control system.

Aspect 18. The load facility of any of aspects 10-17, wherein the load facility control system controls the plurality of electric loads based on a load control signal received over the load control signal interface.

Aspect 19. The load facility of any of aspects 10-18, wherein the software code further causes the processor to receive an amount of energy used in each hour of the twenty-four hour period from the load facility control system.

Aspect 20. An electric load facility and electric load auctioning and curtailment system, comprising a computerized electric load auctioning and curtailment control system that conducts daily auctions of nominated electric load curtailment and awards electric load curtailment; and a load facility comprising a plurality of electric loads; a load facility control system that controls the plurality of electric loads, comprising a load control signal interface; and an electric load curtailment nominating system, comprising a computer processor; memory; a first data transmission interface to the computerized electric load auctioning and curtailment control system; a second data transmission interface to the load facility control system; a user interface comprising a grid of boxes, wherein each box represents an amount of energy during a particular hour; and software code that, when loaded into the memory and run by the processor, causes the processor to accept entry of an amount of energy curtailment nominated for a first hour in a twenty-four hour period and an amount of additional energy needed in a second hour in the twenty-four hour period through the user interface to accommodate the amount of energy curtailment nominated in the first hour; submit an amount of energy curtailment nominated in each hour of the twenty-four hour period and an amount of additional energy nominated in each hour of the twenty-four hour period to the computerized electric load auctioning and curtailment control system through the first data transmission interface; and receive an amount of energy curtailment awarded by auction in each hour of the twenty-four hour period and an amount of additional energy awarded in each hour of the twenty-four hour period through the first data transmission interface.

Particular embodiments of the present disclosure have been described herein, however, it is to be understood that the disclosed embodiments are merely examples of the disclosure, which may be embodied in various forms. Well-known functions or constructions are not described in detail to avoid obscuring the present disclosure in unnecessary detail. Therefore, specific structural and functional details disclosed herein are not to be interpreted as limiting, but merely as a basis for the claims and as a representative basis for teaching one skilled in the art to variously employ the present disclosure in any appropriately detailed structure.

What is claimed is:

1. An electric load curtailment nominating system for a load facility, comprising:
a computer processor;
memory;
a first data transmission interface to a curtailment auctioning and control system;
a second data transmission interface to a load facility control system;
a user interface; and
software code that, when loaded into the memory and run by the processor, causes the processor to accept entry of an amount of energy curtailment nominated for a first hour in a twenty-four hour period through the user interface.

2. The system of claim 1, wherein the software code further causes the processor to accept entry of an amount of additional energy needed in a second hour in the twenty-four hour period through the user interface to accommodate the amount of energy curtailment nominated in the first hour.

3. The system of claim 2, wherein the user interface comprises a grid of boxes, wherein each box represents an amount of energy during a particular hour.

4. The system of claim 3, wherein the software code further causes the processor to determine a total amount of energy curtailment nominated.

5. The system of claim 4, wherein the software code further causes the processor to determine whether a total amount of additional energy matches the total amount of energy curtailment.

6. The system of claim 5, wherein the software code further causes the processor to submit an amount of energy curtailment nominated in each hour of the twenty-four hour period and an amount of additional energy nominated in each hour of the twenty-four hour period through the first data transmission interface.

7. The system of claim 6, wherein the software code further causes the processor to receive an amount of energy curtailment awarded in each hour of the twenty-four hour period and an amount of additional energy awarded in each hour of the twenty-four hour period through the first data transmission interface.

8. The system of claim 7, wherein the software code further causes the processor to send the amount of energy curtailment awarded in each hour of the twenty-four hour period and the amount of additional energy awarded in each hour of the twenty-four hour period through the second data transmission interface.

9. The system of claim 8, wherein the software code further causes the processor to receive an amount of energy used in each hour of the twenty-four hour period through the second data transmission interface.

10. A load facility, comprising:
a plurality of electric loads;
a load facility control system comprising a load control signal interface; and
an electric load curtailment nominating system, comprising:
a computer processor;
memory;
a first data transmission interface to a curtailment auctioning and control system;
a second data transmission interface to the load facility control system;
a user interface; and
software code that, when loaded into the memory and run by the processor, causes the processor to accept entry of an amount of energy curtailment nominated for a first hour in a twenty-four hour period through the user interface.

11. The load facility of claim 10, wherein the software code further causes the processor to accept entry of an amount of additional energy needed in a second hour in the twenty-four hour period through the user interface to accommodate the amount of energy curtailment nominated in the first hour.

12. The load facility of claim 11, wherein the user interface comprises a grid of boxes, wherein each box represents an amount of energy during a particular hour.

13. The load facility of claim 12, wherein the software code further causes the processor to determine a total amount of energy curtailment nominated.

14. The load facility of claim 13, wherein the software code further causes the processor to determine whether a total amount of additional energy matches the total amount of energy curtailment.

15. The load facility of claim 14, wherein the software code further causes the processor to submit an amount of energy curtailment nominated in each hour of the twenty-four hour period and an amount of additional energy nominated in each hour of the twenty-four hour period through the first data transmission interface.

16. The load facility of claim 15, wherein the software code further causes the processor to receive an amount of energy curtailment awarded in each hour of the twenty-four hour period and an amount of additional energy awarded in each hour of the twenty-four hour period through the first data transmission interface.

17. The load facility of claim 16, wherein the software code further causes the processor to send the amount of energy curtailment awarded in each hour of the twenty-four hour period and the amount of additional energy awarded in each hour of the twenty-four hour period to the load facility control system.

18. The load facility of claim 17, wherein the load facility control system controls the plurality of electric loads based on a load control signal received over the load control signal interface.

19. The load facility of claim 18, wherein the software code further causes the processor to receive an amount of energy used in each hour of the twenty-four hour period from the load facility control system.

20. An electric load facility and electric load auctioning and curtailment system, comprising:
a computerized electric load auctioning and curtailment control system that conducts daily auctions of nominated electric load curtailment and awards electric load curtailment; and
a load facility, comprising:
a plurality of electric loads;
a load facility control system that controls the plurality of electric loads, comprising a load control signal interface; and
an electric load curtailment nominating system, comprising:
a computer processor;
memory;
a first data transmission interface to the computerized electric load auctioning and curtailment control system;
a second data transmission interface to the load facility control system;
a user interface comprising a grid of boxes, wherein each box represents an amount of energy during a particular hour; and
software code that, when loaded into the memory and run by the processor, causes the processor to:
accept entry of an amount of energy curtailment nominated for a first hour in a twenty-four hour period and an amount of additional energy needed in a second hour in the twenty-four hour period through the user interface to accommodate the amount of energy curtailment nominated in the first hour;
submit an amount of energy curtailment nominated in each hour of the twenty-four hour period and an amount of additional energy nominated in each hour of the twenty-four hour period to the computerized electric load auctioning and curtailment control system through the first data transmission interface; and
receive an amount of energy curtailment awarded by auction in each hour of the twenty-four hour period and an amount of additional energy awarded in each hour of the twenty-four hour period through the first data transmission interface.
